(19) United States
(12) Patent Application Publication
(10) Pub. No.: US 2023/0350280 A1
(43) Pub. Date: Nov. 2, 2023

(54) PROJECTION APPARATUS

(71) Applicant: HISENSE LASER DISPLAY CO., LTD, Qingdao (CN)

(72) Inventors: Jianjun LI, Qingdao (CN); Xiaoping LI, Qingdao (CN); Xianrong LIU, Qingdao (CN); Yongda HUANG, Qingdao (CN)

(73) Assignee: HISENSE LASER DISPLAY CO., LTD, Qingdao (CN)

(21) Appl. No.: 18/351,257

(22) Filed: Jul. 12, 2023

Related U.S. Application Data
(63) Continuation of application No. PCT/CN2022/082094, filed on Mar. 21, 2022.

(30) Foreign Application Priority Data
Mar. 22, 2021 (CN) 202110302299.6
Mar. 22, 2021 (CN) 202110302300.5

(51) Int. Cl. G03B 21/14; G02B 7/18; H04N 9/31

(52) U.S. Cl. CPC G03B 21/145; G02B 7/18; H04N 9/3161

(57) ABSTRACT

A projection apparatus includes a housing, a laser source, a projection lens, and a light modulation assembly. The housing includes a first opening and a second opening, a laser-exit side of the laser source faces towards the first opening, and a laser inlet side of the projection lens faces towards the second opening. The light modulation assembly includes a lens group, a prism group, a digital micromirror device, and a light-transmitting optical element. A second laser-exit side of the prism group faces towards the second opening, and an orthogonal projection of the laser inlet side of the projection lens on the prism group is within a region where the second laser-exit side of the prism group is located. The light-transmitting optical element is disposed in the housing and is located between the digital micromirror device and the prism group.

### CROSS-REFERENCE TO RELATED APPLICATIONS

This application is a continuation application of International Patent Application No. PCT/CN2022/082094, filed on Mar. 21, 2022, pending, which claims priorities to Chinese Patent Application No. 202110302300.5, filed on Mar. 22, 2021, and Chinese Patent Application No. 202110302299.6, filed on Mar. 22, 2021, which are incorporated herein by reference in their entireties.

### TECHNICAL FIELD

The present disclosure relates to the field of projection technologies, and in particular, to a projection apparatus.

### BACKGROUND

With the progress of science and technology, projection systems are increasingly applied in work and life of people. The projection system mainly includes a projection apparatus and a projection screen. The projection apparatus mainly includes a laser source, a light modulation assembly, and a projection lens. Illumination beams emitted by the laser source are processed by the light modulation assembly and then turned into projection beams, and the projection beams are incident on the projection lens and projected on the projection screen after being diffused by the projection lens, so as to display a projected image.

### SUMMARY

A projection apparatus is provided. The projection apparatus includes a housing, a laser source, a projection lens, and a light modulation assembly. The housing includes a first opening and a second opening. A laser-exit side of the laser source faces towards the first opening, and a laser inlet side of the projection lens faces towards the second opening. The light modulation assembly is disposed in the housing, and the light modulation assembly includes a lens group, a prism group, a digital micromirror device, and a light-transmitting optical element. The lens group is disposed in the housing, and a laser inlet side of the lens group faces towards the first opening. The prism group is disposed in the housing, and a laser-exit side of the lens group faces towards a first laser inlet side of the prism group. A second laser-exit side of the prism group faces towards the second opening, and an orthogonal projection of the laser inlet side of the projection lens on the prism group is within a region where the second laser-exit side of the prism group is located. The digital micromirror device is fixed with the housing, and a reflecting surface of the digital micromirror device faces towards a first laser-exit side of the prism group. The light-transmitting optical element is disposed in the housing and is located between the digital micromirror device and the prism group, and the first laser-exit side and a second laser inlet side of the prism group are a same side and face towards the light-transmitting optical element.

### BRIEF DESCRIPTION OF THE DRAWINGS

In order to describe the technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams but are not limitations on an actual size of a product, an actual process of a method and an actual timing of a signal involved in the embodiments of the present disclosure.

FIG. 1A is a diagram showing a structure of a projection apparatus, in accordance with some embodiments;

FIG. 1B is a sectional view taken along the plane AA in FIG. 1A;

FIG. 1C is a diagram showing structures of a light modulation assembly and a projection lens in the projection apparatus shown in FIG. 1A;

FIG. 1D is a top view of the light modulation assembly in FIG. 1C;

FIG. 2A is a diagram showing a beam path of a light modulation assembly in a projection apparatus, in accordance with some embodiments:

FIG. 2B is a diagram showing a beam path of another light modulation assembly in a projection apparatus, in accordance with some embodiments;

FIG. 3 is a schematic diagram of a number of added pixels in a projected image when a light-transmitting optical element in a light modulation assembly vibrates periodically, in accordance with some embodiments;

FIG. 4A is a diagram showing a structure of alight modulation assembly in the related art;

FIG. 4B is a diagram showing a beam path of the light modulation assembly shown in FIG. 4A;

FIG. 5A is an exploded view of another light modulation assembly, in accordance with some embodiments;

FIG. 5B is a diagram showing a structure of a first bracket in the light modulation assembly in FIG. 5A;

FIG. 6A is a diagram showing an assembled structure of the light modulation assembly shown in FIG. 5A;

FIG. 6B is a sectional view taken along the line BB in FIG. 6A;

FIG. 7A is an exploded view of yet another light modulation assembly, in accordance with some embodiments;

FIG. 7B is an exploded view of a prism group, a light-transmitting optical element and a second bracket in the light modulation assembly shown in FIG. 7A; and

FIG. 7C is an assembly diagram of a prism group, a light-transmitting optical element and a second bracket in the light modulation assembly shown in FIG. 7A.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the expression “connected,” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B or C,” includes the following combinations of A, B, and C: only A, only B, only C, a combination of A and B, a combination of A and C, a combination of B and C, and a combination of A, B, and C.

The use of the phase “configured to” herein means an open and inclusive expression, which does not exclude devices that are applicable to or configured to perform additional tasks or steps.

The term such as “about,” “substantially,” and “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system).

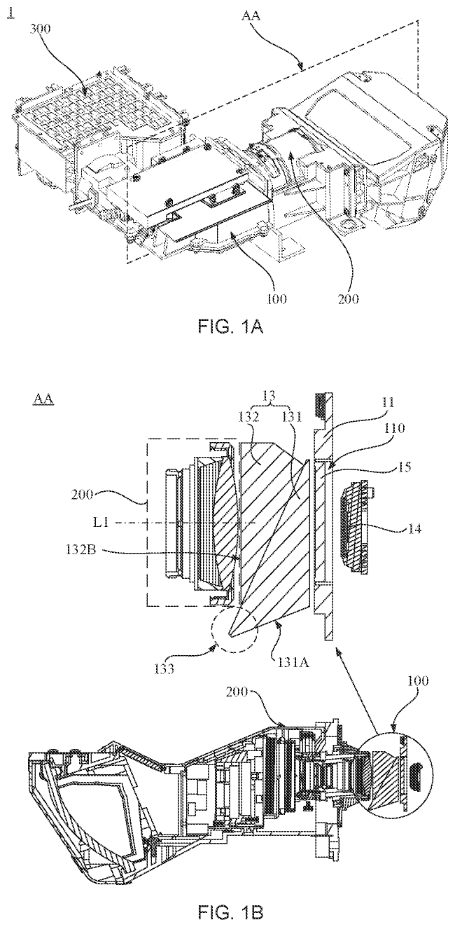

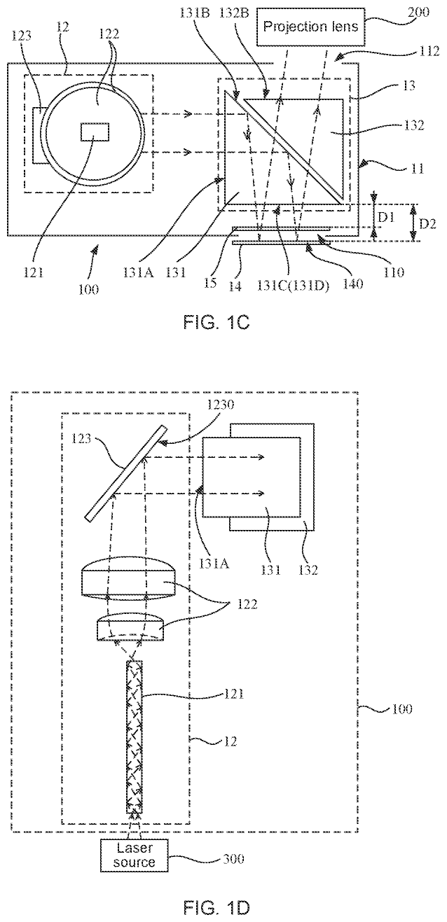

FIG. 1A is a diagram showing a structure of a projection apparatus, in accordance with some embodiments. FIG. 1B is a sectional view taken along the plane AA in FIG. 1A. FIG. 1B shows a partial structure of a light modulation assembly 100.

Some embodiments of the present disclosure provide a projection apparatus 1. As shown in FIGS. 1A and 1B, the projection apparatus 1 includes a housing 11, a laser source 300, a light modulation assembly 100, and a projection lens 200.

The laser source 300 may include solid-state lasers that can emit red, green, and blue laser beams. Alternatively, the laser source 300 may include the solid-state laser and a fluorescent substance, and laser beams emitted by the solid-state laser excite the fluorescent substance, so as to generate light beams of other colors. Alternatively, the laser source 300 may include the solid-state laser and light-emitting diodes (LEDs). Here, the fluorescent substance refers to a device that may convert a monochromatic laser beam into laser beams of three primary colors. For example, the fluorescent substance is a phosphor wheel with phosphor powder.

FIG. 1C is a diagram showing structures of a light modulation assembly and a projection lens in the projection apparatus shown in FIG. 1A, and FIG. 1C shows a simplified structure of the light modulation assembly 100. FIG. 1D is a top view of the light modulation assembly in FIG. 1C. A housing 11, a digital micromirror device 14, and a light-transmitting optical element 15 are not shown in FIG. 1D.

As shown in FIGS. 1B, 1C, and 1D, the light modulation assembly 100 is disposed in the housing 11 and includes a lens group 12, a prism group 13, a digital micromirror device (DMD) 14, and a light-transmitting optical element 15. A laser-exit side of the laser source 300 faces towards a first opening 111 (as shown in FIG. 5A) of the housing 11, and a laser inlet side of the projection lens 200 faces towards a second opening 112 of the housing 11 (referring to FIG. 1C). It will be noted that the housing 11 is configured to accommodate the light modulation assembly 100, and some components of the light modulation assembly 100 may also be fixed outside the housing 11, and the present disclosure is not limited thereto.

As shown in FIGS. 1C and 1D, the lens group 12, the prism group 13, and the light-transmitting optical element 15 each are disposed in the housing 11. A laser inlet side of the lens group 12 faces towards the first opening 111, a laser-exit side of the lens group 12 faces towards a first laser inlet side 131A of the prism group 13, a second laser-exit side 132B of the prism group 13 faces towards the second opening 112, and a first laser-exit side 131C and a second laser inlet side 131D of the prism group 13 are a same side, and the first laser-exit side 131C faces towards the light-transmitting optical element 15. The light-transmitting optical element 15 is located between the DMD 14 and the prism group 13. The DMD 14 is fixed with the housing 11, and a reflecting surface 140 of the DMD 14 faces towards an inside of the housing 11. For example, as shown in FIG. 1C, the reflecting surface 140 of DMD 14 faces towards the first laser-exit side 131C of the prism group 13.

As shown in FIGS. 1C and 1D, illumination beams emitted by the laser source 300 enter the light modulation assembly 100 through the first opening 111 and are incident on the lens group 12. The illumination beams are incident into the prism group 13 through the first laser inlet side 131A of the prism group 13 after exiting from the lens group 12, and a first reflecting side 131B of the prism group 13 reflects the incident illumination beams. The illumination beams reflected by the first reflecting side 131B exit to the light-transmitting optical element 15 through the first laser-exit side 131C of the prism group 13 and are transmitted to the DMD 14 through the light-transmitting optical element 15.

The DMD 14 modulates the incident illumination beams according to an image signal (that is, the illumination beams are controlled to display different luminance and gray scales for different pixels in the image to be displayed), so as to obtain projection beams. The projection beams are reflected from the DMD 14 to the light-transmitting optical element 15. The light-transmitting optical element 15 vibrates periodically according to a received electrical signal and projects the projection beam corresponding to one pixel multiple times, so as to obtain two or more projection beams. The two or more projection beams are sequentially incident on the projection lens 200, so that a single pixel may be displayed multiple times, thereby improving a resolution of the projected image of the projection apparatus 1. The projection beams passing through the light-transmitting optical element 15 are incident into the prism group 13 through the first laser-exit side 131C of the prism group 13 and are incident on the projection lens 200 after passing through the second laser-exit side 132B of the prism group 13 and the second opening 112 in sequence.

In some embodiments, as shown in FIGS. 1C and 1D, the lens group 12 includes a light pipe 121, a lens sub-group 122, and a reflector 123. An end of the light pipe 121 faces towards the first opening 111 of the housing 11, and another end of the light pipe 121 faces towards a laser inlet side of the lens sub-group 122. A reflecting surface 1230 of the reflector 123 faces towards a laser-exit side of the lens sub-group 122 and the first laser inlet side 131A of the prism group 13. In this way, the illumination beams emitted by the laser source 300 are incident on the light pipe 121 and then are incident on the lens sub-group 122 after being homogenized by the light pipe 121. The lens sub-group 122 may first collimate the homogenized illumination beams and then converge the collimated illumination beams. The illumination beams converged by the lens sub-group 122 are incident on the reflecting surface 1230 of the reflector 123. The reflector 123 reflects the incident illumination beams incident on the reflecting surface 1230 to the prism group 13.

It will be noted that, in addition to using the light pipe 121, a fly-eye lens may also be used to homogenize the illumination beams emitted by the laser source 300, and the present disclosure is not limited thereto.

In some embodiments, the prism group 13 may include one of a total internal reflection (TIR) prism and a refraction total internal reflection (RTIR) prism.

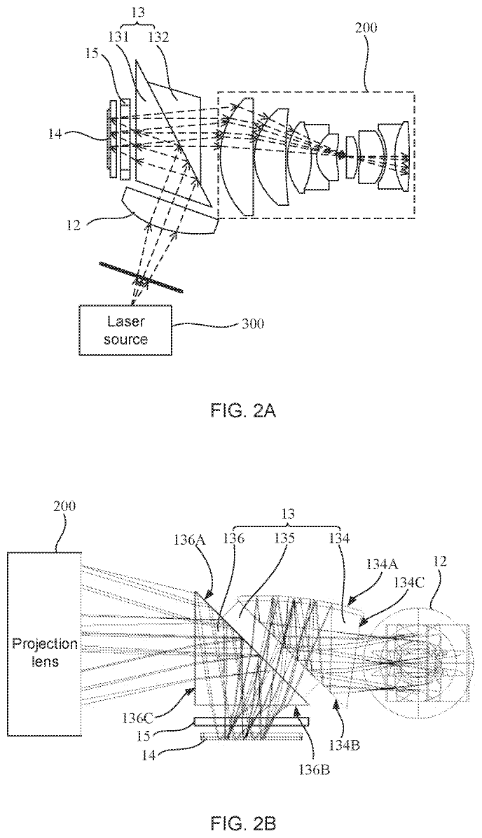

FIG. 2A is a diagram showing a beam path of a light modulation assembly in a projection apparatus, in accordance with some embodiments. FIG. 2B is a diagram showing a beam path of another light modulation assembly in a projection apparatus, in accordance with some embodiments. The prism group 13 shown in FIGS. 1C and 2A is the TIR prism. The prism group 13 shown in FIG. 2B is the RTIR prism.

In some embodiments, in a case where the prism group 13 includes the TIR prism, as shown in FIGS. 1C and 2A, the prism group 13 includes a first prism 131 and a second prism 132. A first surface of the first prism 131 is the first laser inlet side 131A of the prism group 13, and a second surface of the first prism 131 is the first laser-exit side 131C of the prism group 13. A first surface of the second prism 132 is the second laser-exit side 132B of the prism group 13. A third surface of the first prism 131 is the first reflecting side 131B of the prism group 13, and the third surface of the first prism 131 is attached to a second surface of the second prism 132 facing towards the first prism 131.

In some embodiments, the first prism 131 and the second prism 132 each are a triangular prism, and the first prism 131 and the second prism 132 each are fixed by means of bonding. For example, the first prism 131 and the second prism 132 each are a right triangular prism. It will be noted that, the first prism 131 and the second prism 132 each may also be a triangular prism with an obtuse angle.

In some embodiments, in a case where the prism group 13 includes the RTIR prism, as shown in FIG. 2B, the prism group 13 includes a third prism 134, a plane glass 135, and a fourth prism 136. A first surface 134A of the third prism 134 is a curved surface, and a reflective material is disposed on the first surface 134A. Surfaces of the third prism 134 and the fourth prism 136 proximate to each other are a second surface 134B of the third prism 134 and a first surface 136A of the fourth prism 136, respectively, two surfaces of the plane glass 135 in a thickness direction are attached to the second surface 134B of the third prism 134 and the first surface 136A of the fourth prism 136, respectively. A third surface 134C of the third prism 134 is the first laser inlet side 131A of the prism group 13. A second surface 136B of the fourth prism 136 is the first laser-exit side 131C of the prism group 13, and a third surface 136C of the fourth prism 136 is the second laser-exit side 132B of the prism group 13.

The illumination beams exiting from the lens group 12 are incident into the third prism 134 through the third surface 134C of the third prism 134. Then, the illumination beams are totally reflected to the first surface 134A of the third prism 134 at a first interface (i.e., the second surface 134B of the third prism 134) between the plane glass 135 and the third prism 134, and are again totally reflected to the plane glass 135 by the reflective material, and are refracted into the fourth prism 136 at a second interface (i.e., the first surface 136A of the fourth prism 136) between the plane glass 135 and the fourth prism 136. Afterwards, the illumination beams are incident on the light-transmitting optical element 15 from the second surface 136B of the fourth prism 136 and are incident on the DMD 14 through the light-transmitting optical element 15. The DMD 14 modulates the incident illumination beams, so as to obtain the projection beams. After being displaced by the light-transmitting optical element 15, the projection beams are incident into the fourth prism 136 again through the second surface 136B of the fourth prism 136, and are totally reflected to the third surface 136C of the fourth prism 136 at the second interface. Finally, the projection beams exit from the third surface 136C of the fourth prism 136 and are incident on the projection lens 200. Here, a third plane (e.g., the horizontal plane as shown in FIG. 2B) where the first laser-exit side 131C of the prism group 13 is located is perpendicular to a first plane (e.g., the vertical plane as shown in FIG. 2B) where the second laser-exit side 132B is located. That is to say, the second surface 136B of the fourth prism 136 is perpendicular to the third surface 136C of the fourth prism 136, so as to reduce a distance (e.g., propagation path) that the projection beams pass from the DMD 14 to the projection lens 200.

The following description is mainly given by considering an example in which the prism group 13 includes the TIR prism.

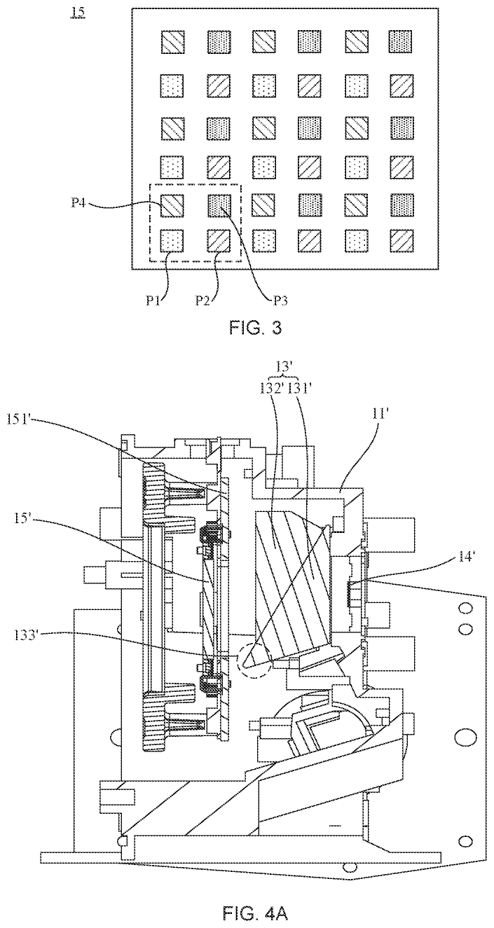

FIG. 3 is a schematic diagram of a number of added pixels in a projected image when a light-transmitting optical element in a light modulation assembly vibrates periodically, in accordance with some embodiments.

In some embodiments, the light-transmitting optical element 15 is configured to move periodically among a plurality of positions driven by an electrical signal. For example, the light-transmitting optical element 15 includes a fixing frame and a light-transmitting optical element body. The fixing frame is disposed in the housing 11, and the light-transmitting optical element body is disposed on the fixing frame. By controlling the fixing frame to move, so as to drive the vibration of the light-transmitting optical element body, it is possible to achieve the periodic movement of the light-transmitting optical element 15 among the plurality of positions.

For example, the light-transmitting optical element 15 moves periodically between a first position and a second position. When the light-transmitting optical element 15 is switched from the first position to the second position, or from the second position to the first position, the corresponding moment when the light-transmitting optical element 15 is located at the first position is a first moment, and the corresponding moment when the light-transmitting optical element 15 is located at the second position is a second moment. Here, the first position may refer to an initial position where the light-transmitting optical element 15 (e.g., the fixing frame) is located when the light-transmitting optical element 15 does not vibrate, and the second position may refer to a position where the light-transmitting optical element 15 is located after the light-transmitting optical element 15 has vibrated. Alternatively, the first position and the second position each are positions where the light-transmitting optical element 15 is located after the light-transmitting optical element 15 has vibrated, and the first position and the second position correspond to the positions of the light-transmitting optical element 15 after the light-transmitting optical element 15 has vibrated in different directions.

In this way, the projection beam corresponding to one pixel may be formed to be two projection beams through the vibration of the light-transmitting optical element 15, and the two projection beams correspond to different moments, respectively. For example, one projection beam corresponds to the first moment, another projection beam corresponds to the second moment, and the first moment is adjacent to the second moment. Moreover, the projection beam exiting from the light-transmitting optical element 15 at the first moment is staggered from the projection beam exiting from the light-transmitting optical element 15 at the second moment, and positions of the two projection beams are different from each other. In this way, the projection beam at the first moment and the projection beam at the second moment are sequentially incident on the prism group 13 and then exit from the prism group 13 to the projection lens 200, so that one pixel is displayed twice, and the resolution of the projected image is improved.

In some embodiments, the light-transmitting optical element 15 may vibrate in a first direction and a second direction. The first direction may be parallel to a long side of a rectangular projected image projected by the projection lens 200, and the second direction may be parallel to a short side of the rectangular projected image projected by the projection lens 200.

In some embodiments, the vibration of the light-transmitting optical element 15 in the first direction and the vibration of the light-transmitting optical element 15 in the second direction may be performed synchronously. In this case, the light-transmitting optical element 15 may be located at the first position after being reset in the first direction and the second direction, and the light-transmitting optical element 15 may be located at the second position after vibrating in the first direction and the second direction. The present disclosure is not limited thereto, in some embodiments, the vibration of the light-transmitting optical element 15 in the first direction and the vibration of the light-transmitting optical element 15 in the second direction may be performed asynchronously. In this case, the light-transmitting optical element 15 is located at the first position after vibrating in the first direction and being reset in the second direction, and the light-transmitting optical element 15 is located at the second position after being reset in the first direction and vibrating in the second direction.

In some embodiments, the light-transmitting optical element 15 may vibrate in a third direction. The third direction may be parallel to a diagonal of the rectangular projected image projected by the projection lens 200. In this case, the light-transmitting optical element 15 is located at the first position after being reset in the third direction, and the light-transmitting optical element 15 is located at the second position after vibrating in the third direction.

Of course, the light-transmitting optical element 15 may also have three, four, or more moving positions. For example, the light-transmitting optical element 15 is configured to move periodically among four positions driven by the electrical signal. For example, as shown in FIG. 3, the light-transmitting optical element 15 moves from a first position P1 to a second position P2, a third position P3, and a fourth position P4 in sequence, so that the projection beam corresponding to one pixel may be divided into the projection beams corresponding to four pixels, thereby improving the resolution of the projected image of the projection apparatus 1.

By using the light-transmitting optical element 15, the projection apparatus 1 may project a 4K image or an 8K image, thereby achieving the high definition (HD) display. The 4K image refers to an image having or substantially having 4096 pixels per row in the horizontal direction without considering an aspect ratio of the image. The 4K image is the Ultra HD image. For example, the 4K image has a resolution of 4096×2160, which is four times the resolution of the 1080P video. That is to say, the number of the pixels of the 4K image in the length and the width directions is twice that of the 1080P video, respectively. Viewers may clearly see every detail in the image at the resolution of the 4K image. The resolution of the 8K image is 4 times that of the 4K image. That is to say, the number of the pixels of the 8K image in the length and the width directions is twice that of the 4K image, respectively. The resolution of the 8K image may be 7680×4320.

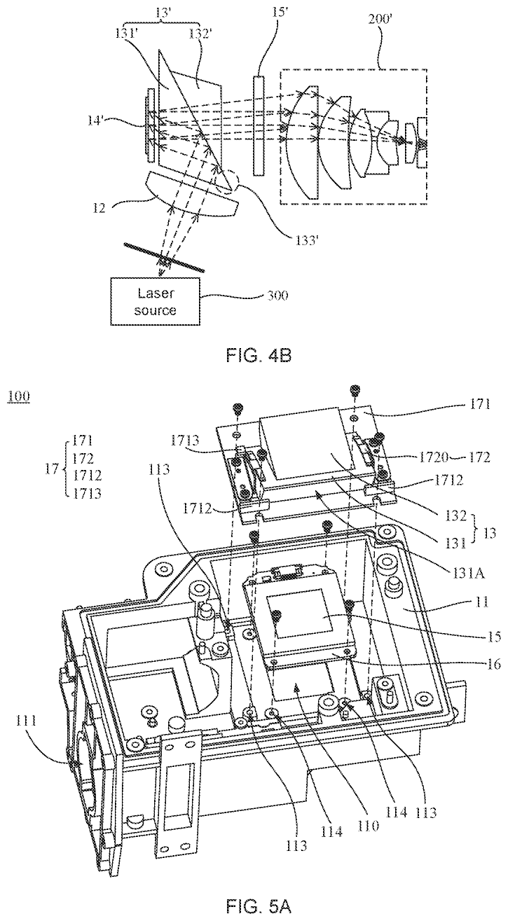

FIG. 4A is a diagram showing a structure of a light modulation assembly in the related art. FIG. 4B is a diagram showing a beam path of the light modulation assembly shown in FIG. 4A.

Generally, a distance between the DMD 14 and the laser inlet side of the projection lens 200 may be shortened, so as to reduce a volume of the light modulation assembly 100, thereby reducing a volume of the projection apparatus 1. However, in the related art, as shown in FIGS. 4A and 4B, a light-transmitting optical element 15′ is located on a side of a prism group 13′ away from a DMD 14′. That is to say, the light-transmitting optical element 15′ is located between the prism group 13′ and a projection lens 200′. In this case, a distance between the light-transmitting optical element 15′ and an inner wall of a housing 11′ is large, thus it is necessary to provide a bracket 151′ to fix the light-transmitting optical element 15′. However, the arrangement of the bracket 151′ may increase the distance between the DMD 14′ and the laser inlet side of the projection lens 200′, which causes a back focal length of the projection lens 200′ to be large. For example, a distance between the prism group 13′ and the projection lens 200′ is 11.3 mm. Even if the bracket 151′ is not used and the light-transmitting optical element 15′ adopts a thin-plate structure, it is also necessary to reserve enough space between the prism group 13′ and the projection lens 200′, so as to place the light-transmitting optical element 15′. In this way, the design requirements for the back focal length of the projection lens 200′ are high, which increases the difficulty of designing the projection lens 200′. Generally, the back focal length, the F number (also known as aperture number or F #) and the projection ratio are some important parameters in the design of projection lens. After the F # and the projection ratio of the optical system are determined, the back focal length becomes the important design parameter of the projection lens. The back focal length usually refers to a distance from a surface of the light modulation assembly 100 to a first group of lenses in a rear group of the projection lens 200. The surface of the light modulation assembly 100 is equivalent to the object plane, and the projection beams exiting from the light modulation assembly 100 are enlarged by the projection lens 200 and imaged on the projection screen.

However, in some embodiments of the present disclosure, the light-transmitting optical element 15 is located between the prism group 13 and the DMD 14. For example, as shown in FIGS. 1B and 1C, the housing 11 includes a fourth through hole 110. The DMD 14 is disposed outside the housing 11, and a portion of the DMD 14 extends into the fourth through hole 110, so that the reflecting surface 140 of the DMD 14 may face towards the inside of the housing 11. In this case, the light-transmitting optical element 15 may be directly disposed on an inner wall of the housing 11, so that the distance between the DMD 14 and the laser inlet side of the projection lens 200 may be reduced without arranging the bracket 151′, thereby reducing the back focal length of the projection lens 200. For example, a distance between the DMD 14 and the prism group 13 is 6.6 mm.

In addition, generally, a thickness of the prism group 13 may also be reduced, so as to further reduce the distance between the DMD 14 and the laser inlet side of the projection lens 200. However, in order to make the prism group 13 totally reflect the illumination beams exiting from the lens group 12, a thickness of the second prism 132 (i.e., a prism of the prism group 13 proximate to the projection lens 200) may be reduced, but a size of the first laser inlet side 131A may not be reduced. As shown in FIGS. 4A and 4B, such arrangement may cause a corner of a first prism 131′ to protrude, so as to form a convex corner 133′. In a case where the light-transmitting optical element 15′ is located between the prism group 13′ and the projection lens 200′, the convex corner 133′ may block the light-transmitting optical element 15′ from approaching the prism group 13′, thereby affecting the projection lens 200′ from approaching the prism group 13′. Therefore, in the case where the light-transmitting optical element 15′ is located between the prism group 13′ and the projection lens 200′, it is impossible to effectively reduce the distance between the projection lens 200′ and the DMD 14′ through reducing the thickness of the prism group 13′.

However, in some embodiments of the present disclosure, as shown in FIG. 1B, the light-transmitting optical element 15 is located between the prism group 13 and the DMD 14, and an orthogonal projection of the laser inlet side of the projection lens 200 on the prism group 13 is within a region where the second laser-exit side 132B of the prism group 13 is located. In this way, after reducing the thickness of second prism 132, in a process of the projection lens 200 approaching the prism group 13, the laser inlet side of the projection lens 200 may not be affected by the convex corner 133, so that the projection lens 200 may approach the prism group 13, thereby reducing the distance between the projection lens 200 and DMD 14.

Moreover, as shown in FIG. 2A, since the distance between the DMD 14 and the projection lens 200 is reduced, it is possible to further reduce an illumination region of the projection beams exiting from the prism group 13 on the projection lens 200, thereby further reducing the volume of the projection lens 200. That is to say, sizes of the lenses included by the projection lens 200 may be reduced, so as to reduce the difficulty of designing the projection lens 200. In addition, in a case where the distance between the projection lens 200 and the prism group 13 is reduced, it is possible to reduce an overall space occupied by the light modulation assembly 100 and the projection lens 200, so as to achieve the miniaturization of the projection apparatus 1.

In some embodiments, the distance between the prism group 13 and the light-transmitting optical element 15 is substantially 1 mm. For example, as shown in FIG. 1C, a distance D1 between the first prism 131 and the light-transmitting optical element 15 is substantially 1 mm, so as to facilitate the propagation of the light beams (e.g., the illumination beams or the projection beams). It will be noted that the distance between the prism group 13 and the light-transmitting optical element 15 may also be other values (e.g., 0.8 mm, 0.9 mm, 1.1 mm, or 1.2 mm), and the present disclosure is not limited thereto.

In some embodiments, a main optical axis (e.g., the dot-dash line L1 in FIG. 1B) of the projection lens 200 is perpendicular to the first plane where the second laser-exit side 132B of the prism group 13 is located. That is to say, a fifth plane where the laser inlet side of the projection lens 200 is located is parallel to the first plane where the second laser-exit side 132B of the prism group 13 is located. In this way, when the projection lens 200 is approaching the prism group 13, the laser inlet side of the projection lens 200 may be as close as possible to the prism group 13, so that the distance between the laser inlet side of the projection lens 200 and the prism group 13 may be reduced.

In some embodiments, a second plane where the DMD 14 is located is parallel to the third plane where the first laser-exit side 131C of the prism group 13 is located. In this way, the DMD 14 may be as close as possible to the prism group 13.

For example, in the case where the light-transmitting optical element 15 is mounted between the DMD 14 and the prism group 13, a distance D2 (as shown in FIG. 1C) between the DMD 14 and the first laser-exit side 131C of the prism group 13 is less than or equal to 10 mm. For example, the distance D2 between the DMD 14 and the first laser-exit side 131C of the prism group 13 is 5.0 mm, 5.4 mm, 5.9 mm, 6.6 mm, 7.0 mm, or 7.2 mm.

In some embodiments, in the case where the light-transmitting optical element 15 is located between the DMD 14 and the prism group 13, and the second plane where the DMD 14 is located is parallel to the third plane where the first laser-exit side 131C of the prism group 13 is located, a fourth plane where the light-transmitting optical element 15 is located is parallel to the second plane where the DMD 14 is located. That is to say, the second plane where the DMD 14 is located, the fourth plane where the light-transmitting optical element 15 is located, and the third plane where the first laser-exit side 131C of the prism group 13 is located are parallel to each other. It will be noted that, there may also be an included angle among the second plane where the DMD 14 is located, the fourth plane where the light-transmitting optical element 15 is located, and the third plane where the first laser-exit side 131C of the prism group 13 is located, as long as the projection beams exiting from the light modulation assembly 100 may be projected normally by the projection lens 200, and the present disclosure is not limited thereto.

In some embodiments, the DMD 14 is fixed inside the housing 11, or fixed outside the housing 11. In a case where the DMD 14 is fixed outside the housing 11, as shown in FIGS. 1B and 1C, the housing 11 has a fourth through hole 110 facing towards the second opening 112. The DMD 14 is fixed on the outside of the housing 11, and the reflecting surface 140 of the DMD 14 is located in the fourth through hole 110 and faces towards the inside of the housing 11.

In this way, a heat dissipation assembly may be directly fixed on the outside of the housing 11, and the heat dissipation assembly may be attached to the DMD 14, so as to achieve the heat dissipation of the DMD 14. That is to say, the DMD 14 is located between the heat dissipation assembly and the housing 11. For example, the heat dissipation assembly includes heat dissipation fins. It will be noted that, the heat dissipation assembly may also be other heat dissipation structures, and the present disclosure is not limited thereto.

The installation manner of the light-transmitting optical element 15 and the prism group 13 in some embodiments of the present disclosure will be described in detail below.

In some embodiments, the light-transmitting optical element 15 and the prism group 13 each may be fixed independently in the housing 11. Alternatively, the light-transmitting optical element 15 and the prism group 13 may be fixed in the housing 11 as a whole.

FIG. 5A is an exploded view of another light modulation assembly, in accordance with some embodiments. FIG. 5B is a diagram showing a structure of a first bracket in the light modulation assembly in FIG. 5A. It will be noted that, in order to show the internal structure of the light modulation assembly 100, FIG. 5A shows a portion of the structure of the housing 11, so that the second opening 112 is not shown in FIG. 5A. It can be understood that the second opening 112 corresponds to the prism group 13 and is located on a side of the prism group 13 away from the fourth through hole 110.

In some embodiments, as shown in FIGS. 5A and 5B, the light-transmitting optical element 15 and the prism group 13 each are fixed independently in the housing 11. In this case, the light modulation assembly 100 further includes a fixing plate 16, and the light-transmitting optical element 15 is disposed on the fixing plate 16. A fixing hole 114 is disposed on the inner wall of the housing 11. A screw passes through the fixing plate 16 and is connected with the fixing hole 114 of the housing 11 in a threaded manner, so that the light-transmitting optical element 15 is fixedly connected with the inner wall of the housing 11, thereby achieving the fixation of the light-transmitting optical element 15.

The light-transmitting optical element 15 is located between the prism group 13 and the inner wall of the housing 11, and it is necessary for the prism group 13 to avoid the light-transmitting optical element 15 when the prism group 13 is installed on the inner wall of the housing 11. Therefore, the housing 11 includes a positioning post 113. For example, a portion of the inner wall of the housing 11 protrudes towards the prism group 13, so as to form the positioning post 113. The prism group 13 is disposed on the positioning post 113, so as to achieve the fixing of the prism group 13 and the housing 11.

In some embodiments, the housing 11 may include a plurality of positioning posts 113. A first portion of the plurality of positioning posts 113 each may be a support post, and a second portion of the plurality of positioning posts 113 each may be a fixing post. The prism group 13 abuts against the support post, so as to support the prism group 13 through the support post. For example, the prism group 13 is disposed on the support post. The fixing post is fixedly connected with the prism group 13. The prism group 13 may be tightly pressed and fixed on the fixing post by means of a fastener (e.g., the screw), so as to achieve the fixation of the prism group 13. For example, the first prism 131 is disposed on the support post, and the first prism 131 is tightly pressed on the fixing post by means of the screw, so that the first prism 131 is fixedly connected with the fixing post, thereby achieving a fixed connection between the prism group 13 and the housing 11.

In a case where the prism group 13 is directly fixedly connected with the positioning posts 113, since an orthogonal projection of the prism group 13 on the inner wall of the housing 11 needs to cover an orthogonal projection of the light-transmitting optical element 15 on the inner wall of the housing 11, the prism group 13 has a large volume and high cost. In order to reduce the volume of the prism group 13, in some embodiments, as shown in FIG. 5A, the light modulation assembly 100 further includes a first bracket 17. The prism group 13 is disposed on the first bracket 17, and the first bracket 17 is disposed in the housing 11.

For example, the first bracket 17 includes a first fixing clamp. The prism group 13 is clamped by the first fixing clamp, and the first fixing clamp is fixed on the positioning posts 113 of the housing 11, so as to achieve the fixation of the prism group 13 and the housing 11 and reduce the cost of the prism group 13. In some examples, the first prism 131 is clamped by the first fixing clamp.

In some embodiments, as shown in FIGS. 5A and 5B, the first bracket 17 includes a first body 171 and a limiting member 172. The first body 171 is disposed in the housing 11. For example, the first body 171 is fixed on the inner wall of the housing 11 through the cooperation of the screws and the positioning posts 113. The limiting member 172 is disposed on the first body 171. The limiting member 172 is configured to fix the prism group 13 on the first body 171, so as to limit the prism group 13. The first bracket 17 further includes a first through hole 1711, and the first laser-exit side 131C of the prism group 13 faces towards the first through hole 1711. The first through hole 1711 is disposed on the first body 171 and runs through the first body 171 along a thickness direction of the first body 171.

The illumination beams exiting from the lens group 12 may pass through the first through hole 1711 after being totally reflected by the prism group 13 and are incident on the DMD 14 after passing through the light-transmitting optical element 15. After the DMD 14 modulates the illumination beams to obtain the projection beams, the projection beams may become the projection beams projecting the 4K image after being processed by the light-transmitting optical element 15, and the projection beams are incident on the prism group 13 through the first through hole 1711.

In some embodiments, the first prism 131 is tightly pressed on the first body 171 by the limiting member 172, so that the prism group 13 may be fixed on the first body 171.

In some embodiments, the first bracket 17 may further include a first groove (e.g., groove), and the first groove is disposed on a surface of the first body 171 proximate to the prism group 13 and is recessed toward an inside of the first body 171. In this way, the prism group 13 (e.g., the first prism 131) may be embedded in the first groove. Moreover, the first through hole 1711 may run through a bottom of the first groove. A size of the first groove may be arranged according to the size of the prism group 13, so as to prevent the prism group 13 from shaking after being embedded in the first groove.

Of course, the manner of fixing the prism group 13 is not limited to the above groove. In some other embodiments, as shown in FIG. 5B, the first bracket 17 further includes a first support portion 1712, and the first support portion 1712 is disposed on the first body 171. The first laser inlet side 131A of the prism group 13 abuts against the first support portion 1712, so that the first support portion 1712 may limit the prism group 13. In this way, the first support portion 1712 may prevent the prism group 13 from moving in a direction perpendicular to the first laser inlet side 131A.

In some embodiments, the first support portion 1712 includes a plurality of blocking blocks 1712A that are collinear with each other, and the plurality of blocking blocks 1712A each are located at an edge of the first laser inlet side 131A, so as to keep away from a region of the first laser inlet side 131A where the illumination beams pass through, thereby preventing the first support portion 1712 from affecting the illumination beams exiting from the lens group 12 to be incident on the first laser inlet side 131A of the prism group 13. For example, as shown in FIG. 5B, the first support portion 1712 includes two blocking blocks 1712A. The first laser inlet side 131A abuts against the two blocking blocks 1712A, and the two blocking blocks 1712A each are located at the edge of the first laser inlet side 131A.

In some embodiments, as shown in FIG. 5B, the first bracket 17 further includes a second support portion 1713. The second support portion 1713 is disposed on the first body 171, and a non-working surface of the prism group 13 abuts against the second support portion 1713, so as to limit the prism group 13 through the second support portion 1713. The non-working surface is adjacent to the first laser inlet side 131A, the first reflecting side 131B, and the first laser-exit side 131C. Since the light beams (e.g., the illumination beams or the projection beams) do not reach the non-working surface of the prism group 13, the non-working surface does not reflect or transmit the light beams.

The structure of the second support portion 1713 is similar to that of the first support portion 1712, and reference may be made to the relevant description of the first support portion 1712, and details will not be repeated herein. The first support portion 1712 and the second support portion 1713 may limit the prism group 13 in the X and Y directions shown in FIG. 5B. Moreover, the prism group 13 may also be limited by the limiting member 172 in the Z direction shown in FIG. 5B, so as to improve the stability of fixation the prism group 13.

In some embodiments, as shown in FIG. 5A, the limiting member 172 includes a first fixing piece 1720, and the first fixing piece 1720 presses on the prism group 13 and is fixedly connected with the first body 171, so as to achieve the fixed connection of the prism group 13 and the first body 171. For example, the limiting member 172 includes two first fixing pieces 1720, which are symmetrically arranged on both sides of the first body 171.

It will be noted that, in addition to the first fixing piece 1720, the limiting member 172 may also include other structures, as long as the prism group 13 may be pressed tightly, and the present disclosure is not limited thereto.

In some other embodiments, in a case where the first bracket 17 includes the second support portion 1713 and the non-working surface of the prism group 13 abuts against the second support portion 1713, the limiting member 172 may include the screw. For example, the first body 171 has a protrusion. The screw is inserted into the protrusion and is connected with the protrusion in a threaded manner. An end of the screw abuts against another non-working surface of the prism group 13, and the another non-working surface is opposite to the non-working surface where the second support portion 1713 of the prism group 13 abuts against.

In this way, in a case where the second support portion 1713 limits one non-working surface of the prism group 13, the screw may abut against the another non-working surface of the prism group 13, so that the prism group 13 may be clamped between the second support portion 1713 and the screw, thereby improving the stability of the fixation of the prism group 13.

In some embodiments, the prism group 13 may be directly disposed on the first body 171, however, the present disclosure is not limited thereto. In some embodiments, as shown in FIG. 5B, the first bracket 17 includes a plurality of first protrusions 1714. The plurality of first protrusions 1714 are disposed on the first body 171 and protrude toward the prism group 13. The plurality of first protrusions 1714 are not all collinear, and the prism group 13 is disposed on the plurality of first protrusions 1714, so that the plurality of first protrusions 1714 may support the prism group 13. Moreover, surfaces of the plurality of first protrusions 1714 in contact with the prism group 13 are substantially coplanar. In this way, by providing the plurality of first protrusions 1714, it is possible to reduce a contact area between the prism group 13 and the first body 171, so as to avoid affecting a flatness of a plane formed by the plurality of first protrusions 1714 while reducing the processing difficulty. For example, as shown in FIG. 5B, the first bracket 17 includes four first protrusions 1714, and the four first protrusions 1714 are arranged in a rectangular shape.

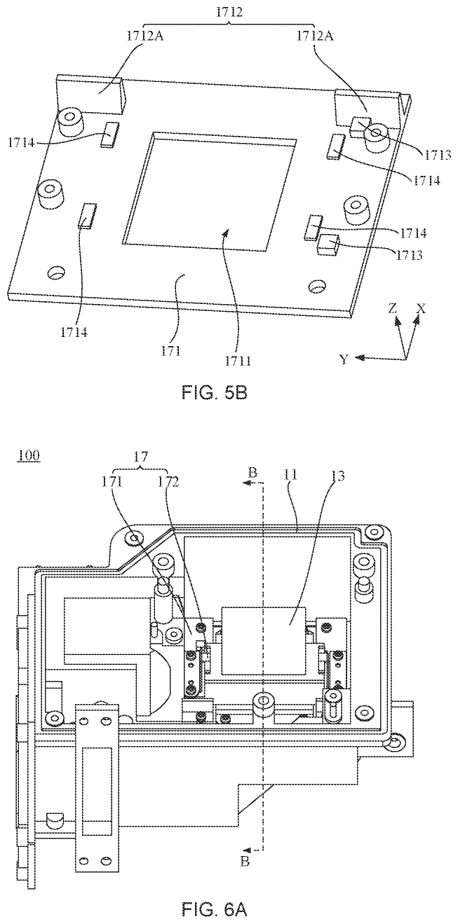

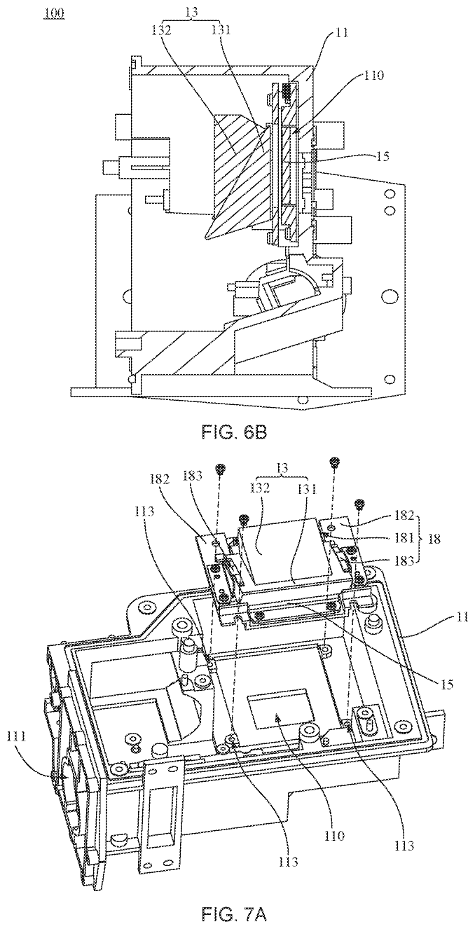

As shown in FIGS. 5A and 5B, the light-transmitting optical element 15 is fixed in the housing 11. The prism group 13 abuts against the first support portion 1712 and the second support portion 1713, and the prism group 13 is tightly pressed and fixed on the first body 171 by the two first fixing pieces 1720. Then the first body 171 is fixed in the housing 11, so as to achieve the fixation of the prism group 13 in the housing 11. The assembled structure of the prism group 13 and the light-transmitting optical element 15 is shown in FIGS. 6A and 6B. FIG. 6A is a diagram showing an assembled structure of the light modulation assembly shown in FIG. 5A. FIG. 6B is a sectional view taken along the line BB in FIG. 6A.

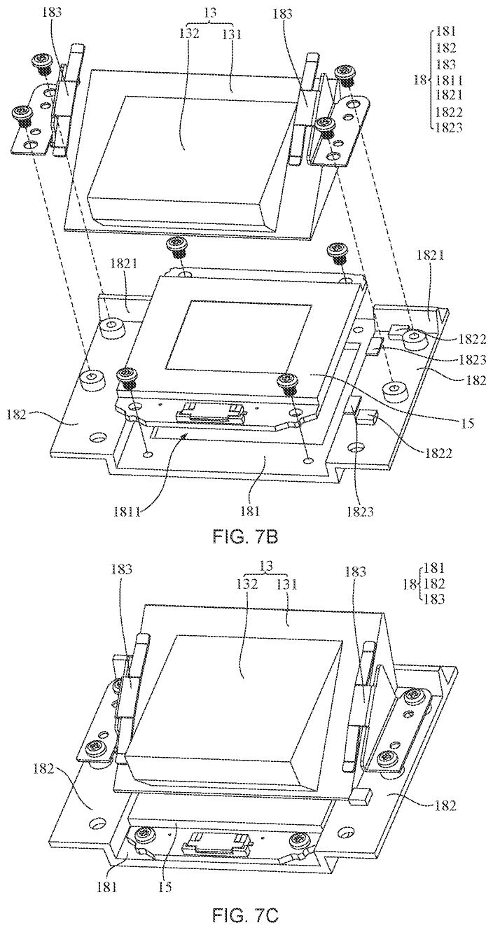

FIG. 7A is an exploded view of yet another light modulation assembly, in accordance with some embodiments. FIG. 7B is an exploded view of a prism group, a light-transmitting optical element, and a second bracket in the light modulation assembly shown in FIG. 7A. FIG. 7C is an assembly diagram of a prism group, a light-transmitting optical element, and a second bracket in the light modulation assembly shown in FIG. 7A. It will be noted that, in order to show the internal structure of the light modulation assembly 100, FIG. 7A shows a portion of the structure of the housing 11, so that the second opening 112 is not shown in FIG. 7A. It can be understood that, the second opening 112 corresponds to the prism group 13 and is located on a side of the prism group 13 away from the fourth through hole 110.

In some embodiments, as shown in FIGS. 7A to 7C, the light-transmitting optical element 15 and the prism group 13 are fixed in the housing 11 as a whole. In this case, the light modulation assembly 100 further includes a second bracket 18. The light-transmitting optical element 15 and the prism group 13 are disposed on the second bracket 18, and the second bracket 18 is disposed in the housing 11.

In some embodiments, the second bracket 18 has a planar structure, and the second bracket 18 includes a second body and a second through hole. The second through hole is disposed on the second body and runs through the second body along a thickness direction of the second body. The light-transmitting optical element 15 is disposed on a first surface of the second body proximate to the DMD 14, and a side of the light-transmitting optical element 15 away from the first surface is attached to the inner wall of the housing 11. The prism group 13 is disposed on a second surface of the second body opposite to the first surface, and the second surface is a surface of the second body away from the DMD 14.

The function of the second through hole of the second bracket 18 may refer to the function of the first through hole 1711 of the first body 171 described above. In addition, a thickness of the second body is greater than or equal to 1 mm, so that the distance between the light-transmitting optical element 15 and the prism group 13 is substantially 1 mm without affecting the strength of the second bracket 18. It will be noted that, in a case where the second bracket 18 has the planar structure, since the first bracket 17 also has the planar structure, the structures of the second body and the second through hole of the second bracket 18 are similar to that of the first body 171 and the first through hole 1711 in FIG. 5B, the first surface of the second body may be construed as the surface of the first body 171 proximate to the DMD 14, and the second surface of the second body may be construed as the surface of the first body 171 away from the DMD 14.

In some embodiments, the second bracket 18 further includes a second groove. The second groove is disposed on one of the first surface and the second surface. In a case where the second groove is disposed on the first surface, the light-transmitting optical element 15 may be embedded in the second groove, so that the light-transmitting optical element 15 may be fixedly connected with the second bracket 18. In a case where the second groove is disposed on the second surface, the prism group 13 may be embedded in the second groove, so that the prism group 13 may be fixedly connected with the second bracket 18.

In some embodiments, the second bracket 18 further includes a plurality of adjusting holes (e.g., strip-shaped holes). The plurality of adjusting holes are disposed on the second body and run through the second body. Moreover, a bolt is disposed in each adjusting hole. The bolt is slidable in the corresponding adjusting hole, and the bolt is configured to be fixedly connected with the light-transmitting optical element 15. Since the bolt is slidable, for the light-transmitting optical elements 15 of different sizes, as long as the bolt is moved to an appropriate position in the adjusting hole, the fixed connection between the bolt and the light-transmitting optical element 15 may be achieved, thereby fixing the light-transmitting optical element 15 on the second bracket 18. In this way, the light-transmitting optical elements 15 of different sizes may be fixed on the second bracket 18, so as to avoid a situation of redesigning the second bracket 18 for the light-transmitting optical elements 15 of different sizes and improving the universality of the second bracket 18.

For the fixing manner of the prism group 13 on the second surface, reference may be made to the above manner of fixing the prism group 13 on the first body 171, and details will not be repeated herein. For example, structures similar to the first support portion 1712 and the second support portion 1713 are arranged on the second surface of the second body, and the prism group 13 abuts against the structures similar to the first support portion 1712 and the second support portion 1713, and the prism group 13 is pressed and fixed on the second surface by a structure similar to the first fixing piece 1720.

In some embodiments, the prism group 13 may be directly disposed on the second surface of the second bracket 18, however, the present disclosure is not limited thereto. In some embodiments, the second bracket 18 further includes a plurality of second protrusions. The plurality of second protrusions are disposed on the second surface and protrude toward the prism group 13. The plurality of second protrusions are not all collinear, and surfaces of the plurality of second protrusions in contact with the prism group 13 are substantially coplanar. The prism group 13 is disposed on the plurality of second protrusions, so that the plurality of second protrusions may support the prism group 13. In this way, by providing the plurality of second protrusions, it is possible to reduce a contact area between the prism group 13 and the second bracket 18, thereby avoiding affecting a flatness of a plane formed by the plurality of second protrusions while reducing the processing difficulty. For example, the second bracket 18 includes four second protrusions, and the four second protrusions are arranged in a rectangular shape.

The above description is mainly given by considering an example in which the second bracket 18 has the planar structure. Of course, in some embodiments, the second bracket 18 may also have a non-planar structure.

As shown in FIGS. 7A to 7C, the second bracket 18 includes a connecting plate 182 and a mounting groove 181. The connecting plate 182 is located on at least one side of the mounting groove 181. The light-transmitting optical element 15 is disposed in the mounting groove 181, and the prism group 13 is disposed on the connecting plate 182. The connecting plate 182 is fixed on the inner wall of the housing 11. For example, the connecting plate 182 is fixed on the inner wall of the housing 11 through cooperation of the screws and the positioning posts 113.

As shown in FIGS. 7A to 7C, the mounting groove 181 is substantially a U-shaped groove and is recessed toward the DMD 14. In this case, the second bracket 18 includes two connecting plates 182, and the two connecting plates 182 are symmetrically disposed on two sides of the mounting groove 181. The second bracket 18 further includes a third through hole 1811, and the third through hole 1811 is disposed on a bottom of the mounting groove 181 and runs through the bottom of the mounting groove 181. The structure and function of the third through hole 1811 are similar to those of the first through hole 1711, and details will not be repeated herein.

A depth of the mounting groove 181 may be adjusted, so as to guarantee the strength of the second bracket 18 on condition that the distance between the light-transmitting optical element 15 and the prism group 13 is 1 mm.

In order to make the light-transmitting optical elements 15 of different sizes be installed in the mounting groove 181, a plurality of adjusting holes may be arranged in the manner that the adjusting holes are disposed on the first surface of the second bracket 18 having the planar structure, and details will not be repeated herein.

The fixing manner of the prism group 13 on the connecting plate 182 may refer to the above manner of fixing the prism group 13 on the first body 171, and details will not be repeated herein.

For example, the second bracket 18 further includes a second fixing clamp, the prism group 13 is clamped by the second fixing clamp, and the second fixing clamp is fixed on the connecting plate 182. Here, the second fixing clamp is similar to the first fixing clamp of the first bracket 17.

Alternatively, the second bracket 18 further includes a third support portion 1821 and a fourth support portion 1822 that are disposed on the connecting plates 182, the third support portion 1821 and the fourth support portion 1822 are similar to the first support portion 1712 and the second support portion 1713, respectively, and the second bracket 18 further includes a second fixing piece 183 similar to the first fixing piece 1720. The prism group 13 abuts against the third support portion 1821 and the fourth support portion 1822, and the second fixing piece 183 presses on the prism group 13 and is fixedly connected with the connecting plate 182.

Alternatively, the prism group 13 is clamped and fixed on the connecting plates 182 through the fourth support portion 1822 and the screw.

It will be noted that, in a case where the prism group 13 is limited by the second fixing piece 183 and the screw, in order to avoid rigid contact between the prism group 13 and one of the second fixing piece 183 and the screw, which may cause damage to the prism group 13, the light modulation assembly 100 may further include a flexible pad. The flexible pad is located between the prism group 13 and one of the second fixing piece 183 and the screw. In this way, the buffering effect of the flexible pad may prevent direct contact between the prism component 13 and one of the second fixing piece 183 and the screw, thereby avoiding damage to the prism group 13.

In some embodiments, the prism group 13 may be directly disposed on the second bracket 18, however, the present disclosure is not limited thereto. In some embodiments, as shown in FIG. 7B, the second bracket 18 further includes a plurality of third protrusions 1823. The plurality of third protrusions 1823 each are disposed on the connecting plates 182 and protrude towards the prism group 13. The plurality of third protrusions 1823 are not all collinear, and surfaces of the third protrusions 1823 in contact with the prism group 13 are substantially coplanar. The prism group 13 is disposed on the plurality of third protrusions 1823, so that the plurality of third protrusions 1823 may support the prism group 13. In this way, by providing the plurality of third protrusions 1823, it is possible to reduce a contact area between the prism group 13 and the second bracket 18, thereby avoiding affecting a flatness of a plane formed by the plurality of third protrusions 1823 while reducing the processing difficulty. For example, as shown in FIG. 7B, the second bracket 18 includes four third protrusions 1823, and the four third protrusions 1823 are arranged in a rectangular shape.

In some embodiments of the present disclosure, the illumination beams emitted by the laser source 300 are modulated and reflected by the DMD 14, and then are incident on the projection lens 200 after passing through the light-transmitting optical element 15 and the prism group 13 in sequence. In this case, since the light-transmitting optical element 15 is attached to the inner wall of the housing 11, there is no need to use the bracket of the light-transmitting optical element 15 when the light-transmitting optical element 15 being fixed, thereby preventing the thickness of the bracket of the light-transmitting optical element 15 from affecting the distance between the DMD 14 and the projection lens 200, so as to shorten the distance between the DMD 14 and the laser inlet side of the projection lens 200. Therefore, a beam spot formed on the projection lens 200 by the projection beams exiting from the prism group 13 is reduced. As a result, it is possible to reduce the volume of the projection lens 200 (i.e., the sizes of the lenses included by the projection lens 200) while avoiding affecting the ability of the projection lens 200 to receive the projection beams, thereby reducing the difficulty of designing the projection lens 200.

In addition, the light-transmitting optical element 15 is arranged between the prism group 13 and the DMD 14. When the projection lens 200 is approaching the prism group 13, the projection lens 200 will not be affected by the convex corner 133 formed after the thickness of the prism group 13 is reduced, so that the projection lens 200 may be as close as possible to the prism group 13, so as to effectively reduce the distance between the projection lens 200 and the prism group 13, thereby reducing the distance between the projection lens 200 and the DMD 14 and achieving the miniaturization of the light modulation assembly 100 and the miniaturization of the projection apparatus 1.

A person skilled in the art will understand that, the scope of disclosure in the present disclosure is not limited to specific embodiments discussed above and may modify and substitute some elements of the embodiments without departing from the spirits of this application. The scope of this application is limited by the appended claims.

What is claimed is:

1. A projection apparatus, comprising:
a housing including a first opening and a second opening;
a laser source, a laser-exit side of the laser source facing towards the first opening;
a projection lens, a laser inlet side of the projection lens facing towards the second opening; and
a light modulation assembly disposed in the housing, the light modulation assembly including:
a lens group disposed in the housing, a laser inlet side of the lens group facing towards the first opening;
a prism group disposed in the housing, a laser-exit side of the lens group facing towards a first laser inlet side of the prism group, a second laser-exit side of the prism group facing towards the second opening, and an orthogonal projection of the laser inlet side of the projection lens on the prism group being within a region where the second laser-exit side of the prism group is located;
a digital micromirror device fixed with the housing, a reflecting surface of the digital micromirror device facing towards a first laser-exit side of the prism group; and
a light-transmitting optical element disposed in the housing and located between the digital micromirror device and the prism group, the first laser-exit side and a second laser inlet side of the prism group being a same side and facing towards the light-transmitting optical element.

2. The projection apparatus according to claim 1, wherein a main optical axis of the projection lens is perpendicular to a first plane where the second laser-exit side of the prism group is located.

3. The projection apparatus according to claim 1, wherein a second plane where the digital micromirror device is located is parallel to a third plane where the first laser-exit side of the prism group is located.

4. The projection apparatus according to claim 1, wherein a fourth plane where the light-transmitting optical element is located is parallel to a second plane where the digital micromirror device is located.

5. The projection apparatus according to claim 1, wherein a distance between the digital micromirror device and the first laser-exit side of the prism group is less than or equal to 10 mm.

6. The projection apparatus according to claim 5, wherein the distance between the digital micromirror device and the first laser-exit side of the prism group is equal to 6.6 mm.

7. The projection apparatus according to claim 1, wherein the prism group satisfies one of the following:
the prism group includes a total internal reflection prism, and a third plane where the first laser-exit side of the prism group is located is parallel to a first plane where the second laser-exit side is located; and
the prism group includes a refractive total internal reflection prism, and the third plane where the first laser-exit side of the prism group is located is perpendicular to the first plane where the second laser-exit side is located.

8. The projection apparatus according to claim 7, wherein the prism group includes a first prism and a second prism;
a first surface of the first prism is the first laser inlet side of the prism group, a second surface of the first prism is the first laser-exit side and the second laser inlet side of the prism group, a first surface of the second prism is the second laser-exit side of the prism group; and
a third surface of the first prism is attached to a second surface of the second prism facing towards the first prism.

9. The projection apparatus according to claim 8, wherein a distance between the prism group and the light-transmitting optical element is substantially 1.1 mm.

10. The projection apparatus according to claim 7, wherein the prism group includes a third prism, a plane glass and a fourth prism;
a first surface of the third prism is a curved surface and a reflective material is disposed on the first surface of the third prism;
two surfaces of the plane glass along a thickness direction are attached to a second surface of the third prism and a first surface of the fourth prism respectively; and
a third surface of the third prism is the first laser inlet side of the prism group, a second surface of the fourth prism is the first laser-exit side of the prism group, and a third surface of the fourth prism is the second laser-exit side of the prism group.

11. The projection apparatus according to claim 1, wherein the light-transmitting optical element and the prism group each are independently fixed in the housing, and the light modulation assembly further includes:
a fixing plate fixed in the housing, the light-transmitting optical element being disposed on the fixing plate; and
a first bracket disposed in the housing, the prism group being disposed on the first bracket.

12. The projection apparatus according to claim 11, wherein the first bracket includes:
a first body;
a limiting member connected with the first body, the limiting member being configured to fix the prism group on the first body, so as to limit the prism group; and
a first through hole running through the first body along a thickness direction of the first body, the first laser-exit side of the prism group facing towards the first through hole.

13. The projection apparatus according to claim 12, wherein the first bracket further includes a groove, the groove is disposed on a surface of the first body proximate to the prism group and recessed toward an inside of the first body, the prism group is embedded in the groove, and the first through hole runs through a bottom of the groove.

14. The projection apparatus according to claim 12, wherein the first bracket further includes a first support portion, the first support portion is disposed on the first body, and the first laser inlet side of the prism group abuts against the first support portion.

15. The projection apparatus according to claim 14, wherein the first support portion includes a plurality of blocking blocks that are collinear with each other, the first laser inlet side of the prism group abuts against the plurality of blocking blocks, and the plurality of blocking blocks each are located at edges of the first laser inlet side.

16. The projection apparatus according to claim 14, wherein the first bracket further includes a second support portion, the second support portion is disposed on the first body, and a non-working surface of the prism group abuts against the second support portion, the non-working surface is adjacent to the first laser inlet side and the first laser-exit side of the prism group.

17. The projection apparatus according to claim 12, wherein the first bracket further includes a plurality of first protrusions, the plurality of first protrusions are not all linear, and surfaces of the plurality of first protrusions in contact with the prism group are substantially coplanar, and the prism group is disposed on the plurality of first protrusions.

18. The projection apparatus according to claim 1, wherein the light-transmitting optical element and the prism group are fixed in the housing as a whole, and the light modulation assembly further includes a second bracket, the second bracket has a planar structure and is disposed in the housing, the second bracket includes:
a second body, the light-transmitting optical element being disposed on a first surface of the second body proximate to the digital micromirror device, and the prism group being disposed on a second surface of the second body away from the digital micromirror device, the first surface and the second surface being opposite to each other; and
a second through hole disposed on the second body and running through the second body along a thickness direction of the second body, the first laser-exit side of the prism group facing towards the second through hole.

19. The projection apparatus according to claim 1, wherein the light-transmitting optical element and the prism group are fixed in the housing as a whole, the light modulation assembly further includes a second bracket, and the second bracket is disposed in the housing and the second bracket includes:
a mounting groove, the light-transmitting optical element being disposed in the mounting groove;
a connecting plate located on at least one side of the mounting groove, and the prism group being disposed on the connecting plate; and
a third through hole disposed on a bottom of the mounting groove and running through the bottom of the mounting groove, the first laser-exit side of the prism group facing towards the third through hole.

20. The projection apparatus according to claim 1, wherein the housing has a fourth through hole facing towards the second opening, the digital micromirror device is fixed outside the housing, and a portion of the digital micromirror device extends into the fourth through hole, so that the reflecting surface of the digital micromirror device faces towards an inside of the housing.
